(19) United States
(12) Patent Application Publication
(10) Pub. No.: US 2017/0262609 A1
(43) Pub. Date: Sep. 14, 2017

(54) PERSONALIZED ADAPTIVE RISK ASSESSMENT SERVICE

(71) Applicant: Lyra Health, Inc., Burlingame, CA (US)

(72) Inventors: Daniella Perlroth, Palo Alto, CA (US); Aaron Archer Waterman, Mountain View, CA (US)

(21) Appl. No.: 15/063,785

(22) Filed: Mar. 8, 2016

(51) Int. Cl. G06F 19/00

(52) U.S. Cl. CPC G06F 19/3431; G06F 19/322; G06F 19/363

(57) ABSTRACT

A behavioral health risk assessment service is provided to determine the behavioral health risk of a patient using personal demographic information and the patient's responses to adaptive screening questions. The screening questions are customized to the patient using machine learning techniques such as decision trees that optimize the amount of expected information gain on the behavioral health risk of the patient. A model of the patient's activity such as exercise and sleep is also generated and trained using data collected from smart devices used by the patient. Based on the determined behavioral health risk, the risk assessment service refers the patient to an appropriate provider, such as a therapist, to treat any diagnosed behavioral health conditions.

### BACKGROUND

This disclosure relates generally to assessing the behavioral health risk of patients and particularly to a personalized adaptive risk assessment service that analyzes a patient's responses to customized questions relevant to the patient's health and lifestyle and determines the patient's behavioral health risk based on the patient's responses.

Digital computing has empowered patient care by providing more personalized and precise patient care. One important aspect of providing personalized health care is finding competent health care providers for a given patient according to the patient's medical conditions and preferences for treatment. Behavioral health is one area in particular where it has been difficult or impossible for patients to find the right psychiatrist, therapist, or the like for effective diagnosis of behavioral health conditions of the patients.

Existing methods for diagnosing behavioral health risk of patients have drawbacks. One of such drawbacks is that existing methods of diagnosis do not provide a personalized risk assessment experience for patients. For example, patients can take a standardized risk assessment questionnaire, where each participating patient is required to respond to standardized questions. Some of these standardized questions may be less relevant to a particular patient while other questions are more relevant. For example, asking the patient if she has had “trouble falling or staying asleep or sleeping too much” does not distinguish whether the patient's trouble is with (1) falling asleep, (2) staying asleep, or (3) sleeping too much. Depending on which of the three possibilities is actually troubling the patient, the patient's diagnosis for behavioral health risk may be different, and thus require seeking a different psychiatrist or therapist for medical treatment.

### SUMMARY

A personalized adaptive risk assessment service is provided to determine behavioral health risk in patients and refer patients to appropriate health care providers based on the behavioral health risk determination. The risk assessment service first presents questions to a patient to receive personal demographic information of the patient and uses the demographic information, along with data from providers and external sources, to generate an initial baseline of behavioral health risk for the patient. Next, the risk assessment service presents the patient with a sequence of screening questions customized to the patient using machine learning techniques such as decision trees. The patient's responses to the questions are compared against the clinically derived baseline for common behavioral health conditions and used to determine the patient's behavioral health risk for conditions such as depression or alcohol and substance abuse. Based on the determined behavioral health risk, the risk assessment service refers the patient to an appropriate health care provider to treat any diagnosed conditions. The risk assessment service generates machine learning models associated with the patient using the demographic information and responses to the screening questions and trains the models over time using responses to the screening questions as well as activity and sleep data collected by smart devices used by the patient.

### BRIEF DESCRIPTION OF THE DRAWINGS

FIG. 1 is a block diagram of a computing environment for diagnosing behavioral health risk in patients according to one embodiment.

FIG. 2 is a flow diagram of determining behavioral health risk of a patient using a risk assessment service according to one embodiment.

FIG. 3 is a block diagram of a personalized risk assessment module of a risk assessment service according to one embodiment.

FIG. 4 is a flowchart illustrating a process of diagnosing behavioral health risk by a risk assessment service according to one embodiment.

FIG. 5A illustrates an example of a graphical user interface of the risk assessment service executing on a client device for a user to input personal demographic information of a patient according to one embodiment.

FIG. 5B illustrates another example of a graphical user interface of the risk assessment service executing on a client device for a user to input personal demographic information of a patient according to one embodiment.

FIG. 6A illustrates an example of a graphical user interface of the risk assessment service executing on a client device for a user to respond to a screening question related to alcohol assumption according to one embodiment.

FIG. 6B illustrates another example of a graphical user interface of the risk assessment service executing on a client device for the user to respond to a screening question selected by the risk assessment service based on the patient's answer to the screening question shown in FIG. 6A according to one embodiment.

FIG. 7 is an example of a decision tree illustrating a sequence of screening questions selected by the risk assessment service according to one embodiment.

FIG. 8 is an example of a chart illustrating normal, uncertain, and concern ranges of a patient's behavioral health risk with respect to the patient's activity levels according to one embodiment.

The figures depict various embodiments of the invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

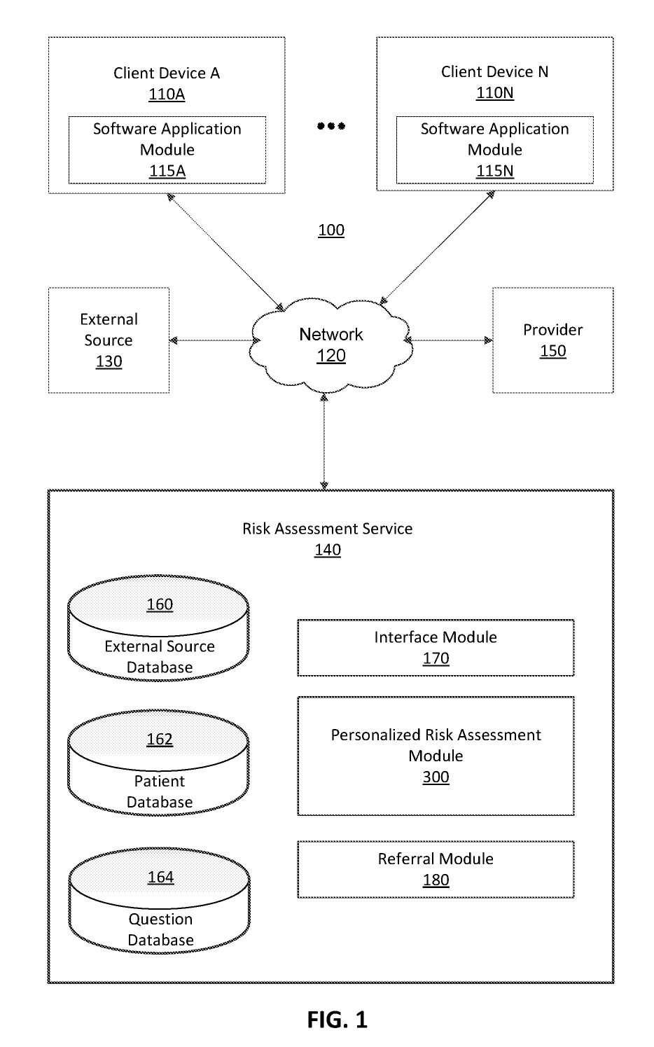

FIG. 1 is a block diagram of a computing environment 100 for diagnosing behavioral health risk in patients according to one embodiment. The embodiment illustrated in FIG. 1 includes multiple client devices 110 (e.g., 110A and 110N), a risk assessment service 140, a health care provider 150, and an external source 130 connected to each other through a network 120. Embodiments of the computing environment 100 can have multiple client devices 110, risk assessment services 140, providers 150, and external sources 130 connected to the network 120. Likewise, the functions performed by the various entities of FIG. 1 may differ in different embodiments.

A client device, e.g., 110A, is an electronic device used by a user to perform functions such as requesting best matched health providers based on a patient's behavioral health risk, executing software applications, consuming web content, browsing websites hosted by web servers on the network 120, downloading files, and the like. For example, the client device 110 may be a mobile device, a tablet, a notebook, a desktop computer, or a portable computer. The client device 110 includes interfaces with a display device on which the user may view webpages, videos and other content. In addition, the client device 110 provides a user interface (UI), such as physical and/or on-screen buttons with which the user may interact with the client device 110 to perform functions such as viewing, selecting, and consuming web content such as digital medical records, webpages, photos, videos and other content. The user may be the patient himself or herself, family, friends, caregivers, clinicians, practitioners, hospitals, a health care service, a skilled nursing facility, an ambulatory surgical center, and some combination thereof or another person associated with the patient.

In one embodiment, the client device 110 has a software application module 115 (e.g., 115A for client device 110A and 115N for client device 110N) for executing a risk assessment software application configured to assess the patient's behavioral health risk and refer an appropriate health care provider for the patient based on the patient's behavioral health risk. The assessment is determined based on various factors, such as demographic information of the patient, external sources (e.g., the patient's medical records from his or her family doctor), and the user's responses to a personalized sequence of screening questions related to the patient's health and lifestyle. The software application is executed to provide a user's input, such as the patient's demographic information and responses to the personalized risk screening questions, to the risk assessment service 140 to determine the patient's behavioral health risk, identify appropriate providers for referral, and receive the identified providers' information from the risk assessment service 140. For example, upon executing the software application installed in the client device 110, the software application module 115 communicates with the risk assessment service 140 to send a request for health care providers for a user using the client device 110, e.g., based on the patient's behavioral health condition risk. Upon receiving the identified providers' information from the risk assessment service 140, the software application module 115 presents the providers' information in an intuitive and user friendly way to the user, e.g., showing the location of an identified provider on a map next to the provider's contact information and web link.

The software application module 115 can be similarly installed and executed on computing devices associated with additional users who have been granted permission to participate in using the risk assessment service 140 on behalf of the patient. The software application module 115 can be a standalone application that a user downloads and uses on a client device 110, or can be integrated into an employee health plan or wellness program at a company at which the patient is employed. In the latter case, the company may also have a software application installed on company devices through which a benefits team can interact with and manage this benefit for employees. Similarly, providers can have software applications installed on their devices or devices associated with their healthcare facility that allow providers to track progress of their patients.

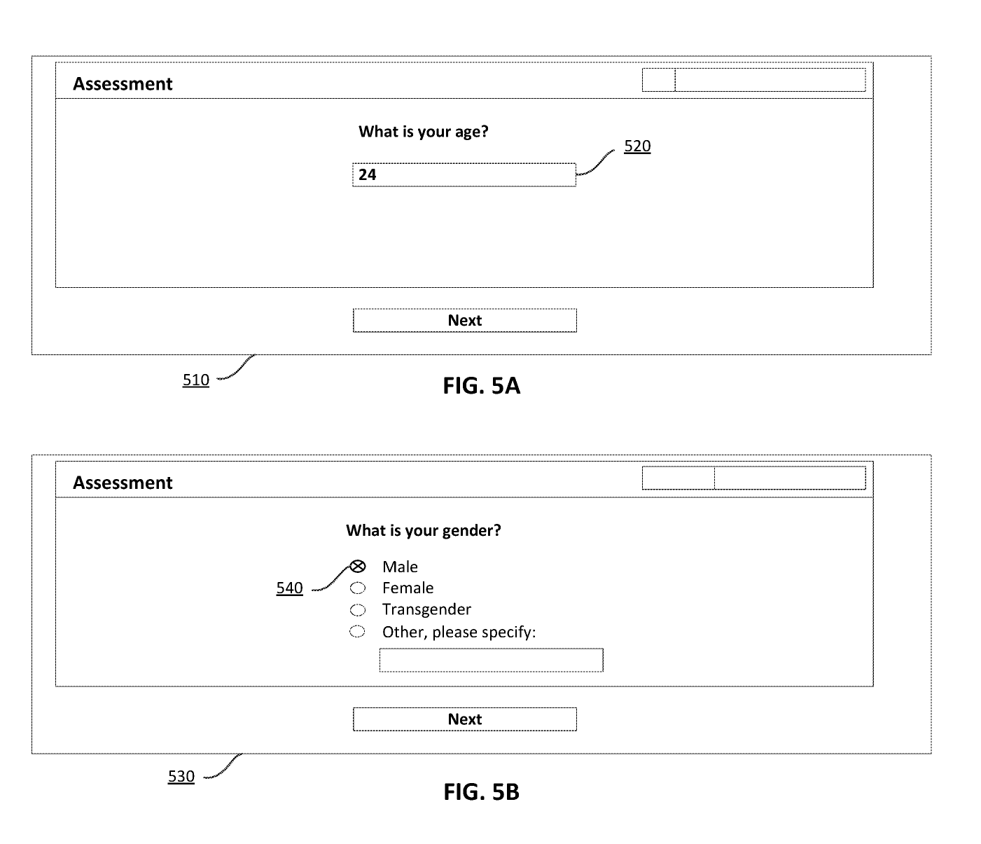

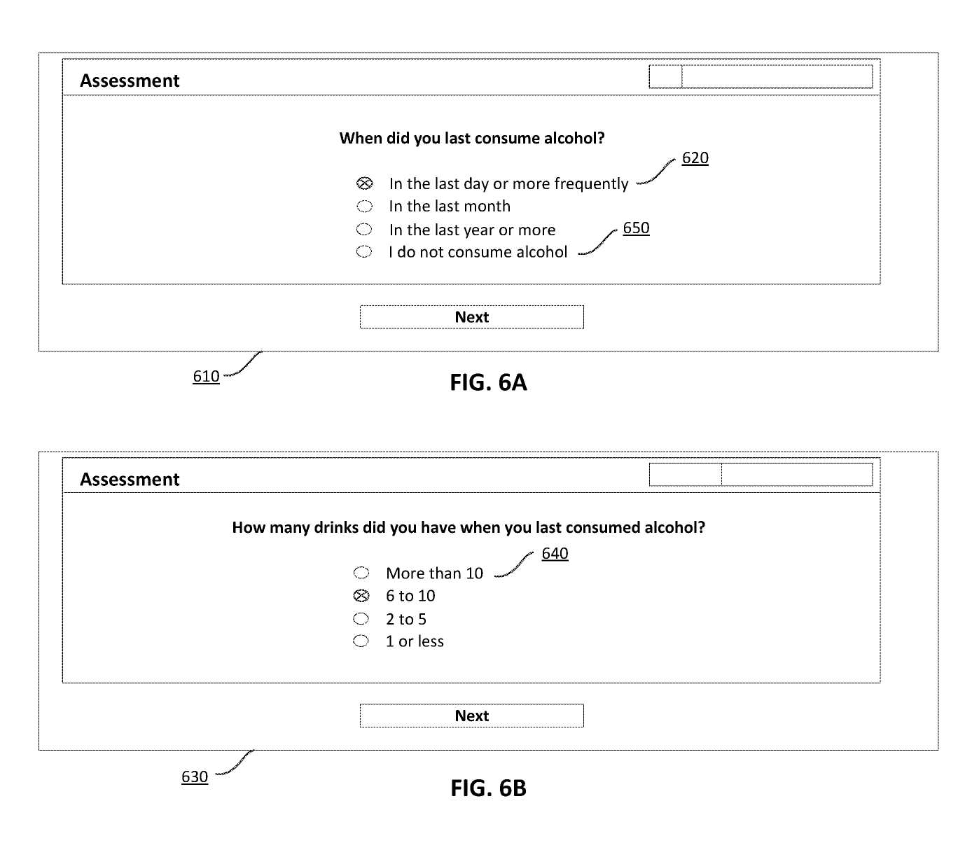

The software application module 115 presents a user-friendly interface for guiding the user to find health care providers appropriate for the patient using the risk assessment application executed on the client device 110. FIG. 5A to FIG. 5B and FIG. 6A to FIG. 6B illustrate examples of a graphical user interface executed by the software application module 115 on the client device 110 such that a user who uses the client device 110 can input the patient's demographic information and responses to the screening questions. The user's input is considered by the risk assessment service 140 to evaluate the patient's behavioral health risk.

Turning now to FIG. 5A, FIG. 5A illustrates an example of a graphical user interface of the risk assessment service 140 executing on a client device 110 for a user to input personal demographic information of a patient according to one embodiment. The user interface 510 presents a question regarding the patient's age and provides a textbox 520 for the patient to input the response, e.g., “24.” FIG. 5B illustrates another example of a graphical user interface of the risk assessment service 140 on a client device 110 for a user to input personal demographic information of a patient according to one embodiment. The user interface 530 presents a question regarding the patient's gender and provides a combination of radio buttons and a textbox 540 for the patient to input the response, e.g., “male.” Various other types of demographic and personal information can be requested, such as a patient's ethnicity, weight, height, mental state, etc. The demographic information about the patient is used by the risk assessment service 140, along with data from the external source 130 and/or external source database 160 such as clinical guidelines and research studies identifying risk for depression associated with demographic groups, to generate an initial baseline of behavioral health risk of the patient. For example, the demographic information about the patient's age is used by the risk assessment service 140 along with clinical guidelines and research studies identifying risk for depression associated with different age groups to generate an initial baseline of behavioral health risk of the patient in terms of depression. The risk assessment service 140 uses the patient's gender data along with other data, such as clinical guidelines and research studies suggesting association of particular gender groups with risk of developing eating disorders, to generate an initial baseline of behavioral health risk of the patient in terms of eating disorder.

Returning back to FIG. 1, the network 120 enables communications among network entities such as the client devices 110, the risk assessment service 140, the external source 130, and the provider 150. In one embodiment, the network 120 comprises the Internet and uses standard communications technologies and/or protocols, e.g., BLUETOOTH®, WiFi, ZIGBEE®, clouding computing, other air to air, wire to air networks, and mesh network protocols to client devices, gateways, and access points. In another embodiment, the network entities can use custom and/or dedicated data communications technologies.

The external source 130 provides information that facilitates the behavioral health risk assessment performed by the risk assessment service 140. The database of the external source 130 may also store medical practice standards (e.g., prescribing guidelines of consensus practice recommendations for different treatments and medication for different medical conditions). In some embodiments, the information stored in the external source 130 is collected each time an assessment is conducted with a patient and is utilized in the assessment using the risk assessment service 140. In other embodiments, the risk assessment service 140 builds up one or more of its own databases (e.g., see FIG. 1) of information about providers either in advance or as assessments are performed such that the risk assessment service 140 can utilize its own source of information about providers. Such a risk assessment service database can be updated regularly to ensure the most accurate and up-to-date information is kept on hand.

The external source 130 may also include historical health data of a patient (e.g., a patient's electronic medical records, or EMRs) from various health record sources (e.g., hospital records, records at the patient's family doctors, or manually inputted data related to the patient's health by the patient's caretakers). The historical health data of a patient describes a global view of the patient's lifestyle and wellness.

In one embodiment, the provider 150 includes one or more databases storing information about health providers (e.g., National Provider Identifier (NPI) provided by National Plan & Provider Enumeration System (NPPES), U.S. physician prescribing data (i.e., drugs prescription) provided by First DataBank, Medicare Part D and IMS HEALTH, patient statistics and evidence-based therapies provided by online resources such as UPTODATE®, SK&A, LEXISNEXIS®, and web crawling. Health providers are also referred to herein as health care providers, providers, physicians, psychiatrists, and therapists.

The risk assessment service 140 analyzes the patient input data (e.g., demographic information and responses to screening questions), data from the provider 150, data from the external source 130, and/or data from a local database, and determines behavioral health risk based on the analysis of the patient input data and the patient's historical health data from the external source 130. In one embodiment, based on the determined risk, the risk assessment service 140 provides information to a provider matching the patient's behavioral health condition. The behavioral health conditions for which risk is assessed can include any Diagnostic and Statistical Manual of Mental Disorders (DSM)-recognized condition, such as depression, anxiety, alcohol or substance abuse, attention deficit hyperactivity disorder (ADHD), post-traumatic stress disorder (PTSD), specific phobias, social anxiety, bipolar disorder and schizophrenia or psychosis in addition to medical conditions with strong behavioral health risk components such as obesity and diabetes. The risk assessment service 140 is further described below and with reference to FIGS. 1-4 and FIGS. 6A-8.

### Personalized Risk Assessment Service

The risk assessment service 140 assesses the behavioral health risk of a patient and refers the patient to an appropriate health care provider based on the behavioral health risk assessment. The patient's behavioral health risk diagnosis may indicate that the patient has suffered from or is prone to behavioral health risks such as eating disorder, bipolar disorder, post-traumatic stress disorder, attention deficit disorder, substance abuse, and schizophrenia. Based on the patient's diagnosis, the risk assessment service 140 recommends one or more appropriate psychiatrists, therapists, or the like to the patient for a personalized health care service.

In the embodiment illustrated in FIG. 1, the risk assessment service 140 has an external source database 160, a patient database 162, a question database 164, an interface module 170, a personalized risk assessment module 300, and a referral module 180. In alternative configurations, different and/or additional components may be included in the risk assessment service 140. For example, the risk assessment service 140 may integrate with various third party hardware or software to provide a comprehensive solution to users of the risk assessment service 140. The risk assessment service 140 can also integrate the health data analysis from the personalized risk assessment module 300 into a user's electronic medical records. Similarly, functionality of one or more of the components may be distributed among the components in a different manner than is described herein.

The external source database 160 stores data received from the external source 130 and the provider 150. The received data includes provider data, medication data, guideline data and disqualifying events associated with the providers. The provider data includes the information associated with the providers (e.g., NPI, medication prescription data, expertise, provider profile, provider locations, and contact information). The medication data includes the information associated with prescribing of medications (e.g., drug description, side effects, drug composition, different types of medication associated with different medication conditions, place of production, and price). The guideline data includes data associated with practice standards (e.g., prescribing guidelines of consensus practice recommendations for different treatments and medications prescribed for different medical conditions). The disqualifying events include information that disqualifies a provider for treating a patient. Examples of disqualifying events include a revoked license, a disciplinary action, retirement from practice and an indication that the provider is not accepting new patients. In some embodiments, this provider database is a proprietary database of providers and information about them collected from public and private sources (e.g., web and social data) used to profile the competency of providers based on what the providers actually do (e.g., what types of conditions they treat, what medications they prescribe, how often they prescribe medications versus psychotherapy or other treatments, etc.) as opposed to what the providers claim to do (e.g., in a description on their personal website).

The patient database 162 stores input data received from the client device 110. The received input data may include a patient's demographic information (e.g., age, gender, and ethnicity). The input data may also include the patient's medical records, patient's drug prescription(s), consumption information for drug prescriptions (e.g., whether the patient adhered to the medication regimen prescribed), activity data, such as activity levels over a period of time received from smart devices of the patient (e.g., FITBIT® and APPLE® HEALTHKIT), and self-reported j ournaling data. For example, the patient may input a description of an event that she experienced and any associated emotions (e.g., positive emotions associated with a birthday party including “joyful” and “enthusiastic” and negative emotions associated with a failing a class exam including “worried” and “depressed”). In another example of journaling data, the patient inputs an indication of her overall mood, e.g., “happy” or “sad.”

The question database 164 stores screening questions that can be selected by the personalized risk assessment module 300 to present to the user. The screening questions may be received from an external source 130, a provider 150, an online database 220, or a behavioral health expert via the client device 110. For example, the external source 130 may include a list of screening questions from a questionnaire posted on an online database, the provider 150 may include screening questions written by a therapist, and the health expert may manually upload a document including screening questions she has written via the client device to the risk assessment service 140. In one embodiment, the questions database 164 is partitioned to two subsets: the first subset contains training data to train a patient screener module, and the second subset stores personalized questions selected for each individual patient of the risk assessment service 140. In one embodiment, the training data is retrieved from publicly available behavioral health risk assessment questionnaires and clinically derived data. A behavioral health expert or the like (e.g., a physician or psychiatrist) can also manually input training data to the risk assessment service 140. The personalized questions selected for each individual patient of the risk assessment service 140 is continuously updated in response to changes and updates of each patient's specific behavioral health conditions.

The interface module 170 facilitates the communication among the client device 110, the risk assessment service 140, the external source 130, and the provider 150. In one embodiment, the interface module 170 interacts with the client devices 110 to receive user input data and stores the received user input data in the patient database 162. The interface module 170 also provides the received patient input data to the personalized risk assessment module 300 for further processing. Upon receiving results from the risk assessment module 300, the interface module 170 instructs the software application module 115 of the client device 110 to display the results. In response to additional data of a patient being available, e.g., the patient's activity data and sleep monitoring data, the interface module 170 sends reminders and recommendations (in text or voice) to the patient for reevaluation by the risk assessment service 140. In another embodiment, the interface module 170 provides software updates, such as feature updates and security patches, to the software application module 115 of the client device 110 for smooth and secure operation of the software application on the client device 110.

The interface module 170 also facilitates the communication among the external source 130, the provider 170 and the personalized risk assessment module 300, such storing data received from the external source 130 and the provider 170 and notifying the personalized risk assessment module 300 about the received information.

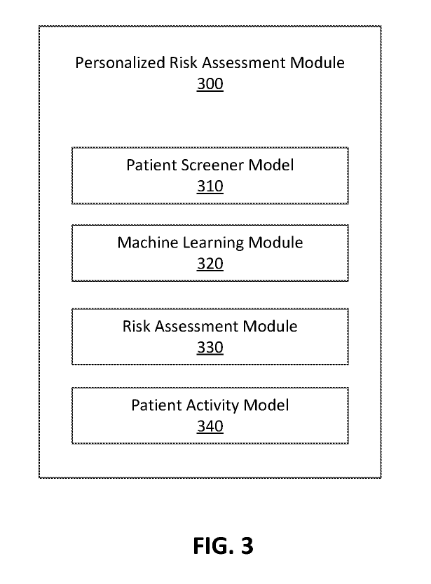

The personalized risk assessment module 300 trains a patient screener model 310 using a corpus of training data and uses the trained module to select a personalized and adaptive sequence of screening questions to determine the behavioral health risk of a patient. For example, the personalized risk assessment module 300 generates an initial baseline of behavioral health risk of the patient based on the patient's responses to questions regarding the patient's demographic information presented to the user (e.g., as shown in FIG. 5A and FIG. 5B). The personalized risk assessment module 300 updates the initial baseline of the patient's behavioral health risk based on the patient's responses to the personalized and adaptive sequence of screening questions presented to the patient (e.g., as shown in FIG. 6A and FIG. 6B). The patient's behavioral health risk may also be updated based on patient activity data (e.g., sleep data recorded by a smart device), self-reported data (e.g., an indication of a mood of the patient), and any other data received by the risk assessment service 140. The personalized risk assessment module 300 is further explained in conjunction with description of FIG. 3.

The referral module 180 generates referrals associated with best matched health care providers for a patient based on the patient's behavioral health risk assessment. The referral module 180 can provide a list of matched providers as the referrals. The list of the matched providers includes information associated with each matched provider, e.g., contact information, location, NPI number, gender, new patient acceptance status, availability, related medical conditions and treatments that the provider handles, language, education, work experience, and other suitable information related to the matched providers. In some embodiments, the referral module 180 also generates instructions on how to present the referrals, and provides the presentation instructions associated with referrals to the client device 110 for display to the user.

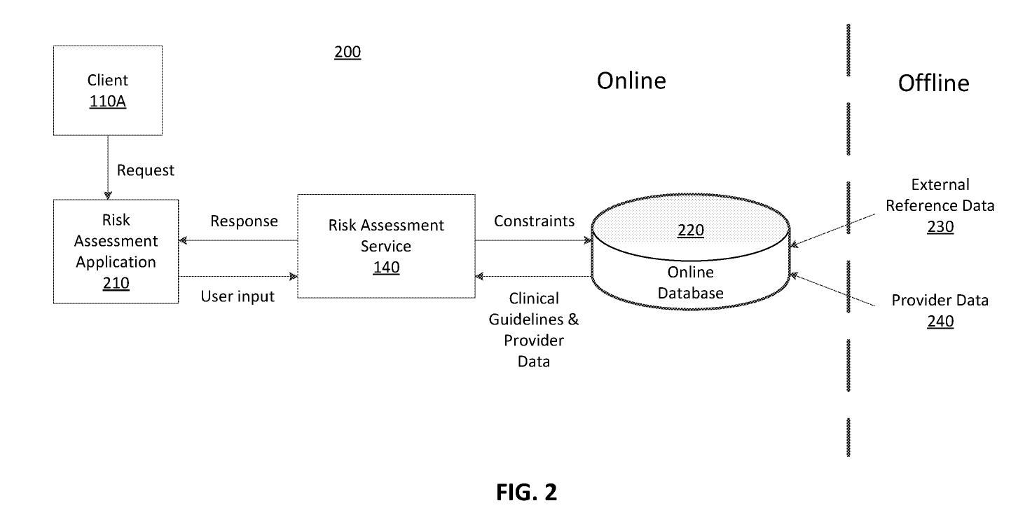

FIG. 2 is a flow diagram of determining behavioral health risk of a patient using the risk assessment service 140 according to one embodiment. Initially, a user (e.g., a patient) uses his/her client device 110A that executes a risk assessment application 210 on the client device 110A to send a request to the risk assessment service 140 for determining his/her behavioral health risk. The risk assessment service 140 receives the request and user input from the patient such as responses to questions regarding the patient's demographic information presented to the user. The risk assessment service 140 generates an initial baseline of behavioral health risk of the patient using the patient's demographic data as constraints and clinical guidelines stored in an online database 220. The risk assessment service 140 responds to the user's request by providing a sequence of one or more personalized and adaptive screening questions in an order that is determined for optimizing the amount of information gain regarding the patient's behavioral health risk. The user's answers to the screening questions are received by the risk assessment service 140 as user input. The risk assessment service 140 uses the user input and clinical guidelines to further determine the patient's behavioral health risk.

The online database 220 stores information from external reference data 230, such as prescribing guidelines of consensus practice recommendations for different treatments and medication for different medical conditions, and provider data 240, such as disqualifying events associated with the providers and providers' medication prescribing data. Based on the patient's determined risk, the risk assessment service 140 selects one or more best matched providers and provides the selected providers as a part of the response to the patient. The patient uses the received response to select his/her provider(s) to treat his/her behavioral health condition. In one embodiment, the risk assessment service can be performed in real time (i.e., online) and the online database 220 can be updated offline. The information stored in the online database 220 can also be used by the machine learning module 320 to train the patient screener model 310 and/or the patient activity module, which are further described along with FIG. 3.

### Personalized Risk Assessment

FIG. 3 is a block diagram of a personalized risk assessment module 300 of the risk assessment service 140 according to one embodiment. In the embodiment illustrated in FIG. 3, the personalized risk assessment module 300 has a patient screener model 310, machine learning module 320, risk assessment module 330, and patient activity model 340. In alternative configurations, different and/or additional components may be included in the personalized risk assessment module 300. Similarly, functionality of one or more of the components may be distributed among the components in a different manner than is described here.

The patient screener model 310 selects a sequence of personalized and adaptive screening questions from the question database 164 (shown in FIG. 1) to present to the user. The screening questions are personalized because each patient is provided with a different sequence of screening questions that are specifically customized for the particular patient being assessed based on the patient's demographic data, activity data and clinical guidelines for behavioral health risk assessment. The selected screening questions are adaptive for a patient because the patient screener model 310 selects subsequent screening questions based on the patient's responses to one or more previous screening questions. The order to present the sequence of personalized questions for each patient is learned through training on training data.

Turning now to FIG. 6A, FIG. 6A illustrates an example of a graphical user interface 610 of the risk assessment service 140 executing on a client device 110 for a patient to respond to a screening question related to alcohol assumption according to one embodiment. The user interface 610 presents the question “when did you last consume alcohol?” and four answer choices along with radio buttons for the patient to input the response. The patient selects the response “in the last day or more frequently” 620 as his/her answer, as indicated by the corresponding marked radio button. FIG. 6B illustrates another example of a graphical user interface 630 of the risk assessment service 140 on the client device 110 for the patient to respond to a screening question selected by the patient screener model 310 based on the patient's answer to the screening question shown in FIG. 6A according to one embodiment. The user interface 630 presents the question “how many drinks did you have when you last consumed alcohol?” The response “6 to 10” 640 is selected by the patient, as indicated by the corresponding marked radio button. If the user selected the response “I do not consume alcohol” 650 in the previous question shown in FIG. 6A, asking the question “how many drinks did you have when you last consumed alcohol?” would not be relevant; instead, the patient screener model 310 would select a question that is designed to evaluate another aspect of the patient's behavioral health risk, such as depression linked to lack of sleep, or closes the screening process for alcohol consumption in particular.

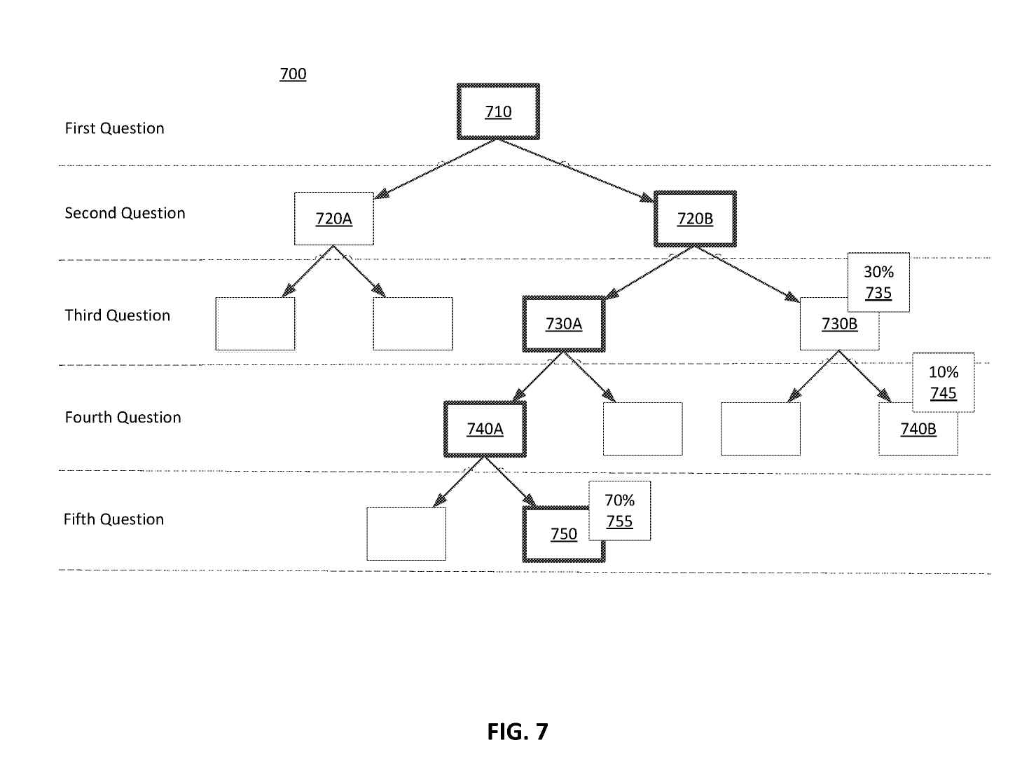

Turning back to FIG. 3, in one embodiment, the patient screener model 310 is trained by the machine learning module 320 to select a sequence of personalized and adaptive questions for each individual patient. The machine learning module 320 trains the patient screener model 310 using a corpus of training data such as the questions stored in the question database 164 shown in FIG. 1. In one embodiment, the corpus of training data used by the machine learning module 320 is data collected from the external sources 130, such as mental health assessment questions provided by various behavioral health care providers and research institutes, and/or the clinical data accumulated by the risk assessment service 140. In one embodiment, the machine learning module 320 uses machine learning techniques including, but not limited to, stochastic gradient descent and decision trees, to train the patient screener model 310. For example, the machine learning module 320 uses a decision tree to model and/or predict the expected value of each possible question in a set of candidate questions selected from the corpus of training data, which is further described with FIG. 7. Based on the total expected value (e.g., expected amount of information gain about the patient) from each possible question in the decision tree, the machine learning module 320 trains the patient screener model 310 to select the next question to be presented to the patient.

### Decision Tree Model

Turning now to FIG. 7, FIG. 7 is an example of a decision tree 700 illustrating a sequence of screening questions selected by the patient screener model 310 according to one embodiment. In the example shown in FIG. 7, the depth of the decision tree 700 is five, indicating at least a sequence of five questions are selected for a particular patient, and the decision tree 700 is a binary tree, where each node (representing a candidate question) has two children nodes (representing two possible subsequent candidate questions for selection). In some embodiments, the decision tree 700 may have more or fewer screening questions, different screening questions, and/or a different structure (e.g., two or more children nodes per node in the tree).

The first screening question 710 (e.g., the first screening question shown in FIG. 6A) initially presented to the patient. Based on the patient's answer to the first screening question 710, the two candidate questions, 720A and 720B, are analyzed based on optimizing the amount of information gain about the patient provided by each candidate question, 720A and 720B. The patient screener model 310 selects one question (e.g., the question shown in FIG. 6B) from the two candidate questions, which provides the optimized amount of information about the patient's behavioral health risk, e.g., question 720B in the example shown in FIG. 7. The patient screener model 310 proceeds similarly with the remaining questions and selects question 730A as the third screening question, 740A as the fourth screening question and 750 as the fifth screening question.

In an example use case of the decision tree, the machine learning module 320 generates a score for at least one of the nodes in a decision tree in the patient screener model 310. For instance, as illustrated in FIG. 7, the node (i.e., candidate question) 730B has a score 735 of 30%, the node 740B has a score 745 of 10%, and the node 750 has a score 755 of 70%. In this example, the score is a percentage that indicates the predicted likelihood that the user's response to the corresponding candidate question, if selected, will result in gaining useful information about a patient that the machine learning module 320 can use to update the patient screener model 310. The initial values of the scores can be generated based on the demographic information about the patient received from the risk assessment service 140 along with information from the provider 150, external source 130, the databases of the risk assessment service 140, and the client device 110. For instance, based on the demographic information, if the patient's age is 24, a question related to alcohol or substance abuse would have a higher score than if the patient's age was 10 because a 10 year old patient is unlikely to consume alcohol. Thus, the machine learning module 320 may train multiple patient screener models 310 for different patients because each patient will have unique demographic information, medical needs, etc. Following in the same example considering a 24 year old patient, the node 750 has a higher score than node 730B and 740B because the candidate question corresponding to node 750 is related to alcohol consumption, while the candidate questions corresponding to node 730B and node 740B are related to a topic less likely to be relevant to a 24 year old patient (e.g., if the patient is experiencing memory loss). The machine learning module 320 updates the scores over time by training the patient screener model 310 using training data and/or training sets such as previous responses by the user or other users of the personalized risk assessment service 140. Scores may be increased, decreased, or maintained at the same value depending on the training. For example, if no 1 year old patients are diagnosed with a high risk of alcohol abuse by the personalized risk assessment service 140, then the scores for alcohol related candidate questions in decision trees associated with 1 year old patients would be decreased. Based on the scores, the patient screener model 310 may avoid nodes or sequences of nodes in the decision tree that have a lower likelihood of resulting in useful information about the patient. The patient screener model 310 will select nodes such that it can reach candidate questions with a high score in the decision tree.

In other embodiments of the decision tree, the score generated by the machine learning module 320 may be represented by a percentage value (e.g., 8%), numerical value (e.g., 1.0), clear text (e.g., “high priority”), Boolean (e.g., “true” or “false”), or another form of data (e.g., alphanumeric data such as “Al”). A different score may be associated with each question and/or question answer choice in the decision tree. For example, a greater numerical value may indicate that the corresponding question includes possible responses that have a significant influence toward a given medical diagnosis. As screening questions are located further down in the decision tree (e.g., a question in the fifth row of the tree shown in FIG. 7), the numerical value of the scores corresponding to the screening question may increase to indicate that more information can be gained from the responses to questions deeper in the tree. In a different example, a clear text score may indicate different types of values such as “morning,” “afternoon,” and “night.” A question related to a patient's diet during lunch would have a score of type “afternoon” because lunch is typically eaten in the afternoon time. Thus, the patient screener model 310 is more likely to select the question related to lunch when the personalized risk assessment service 140 is used during the afternoon time range instead of during the morning or night time ranges. In another example, a Boolean score may indicate whether the corresponding question is “required” or “not required” (e.g., based on how important the question is to determining the patient's behavioral health risk). If the question is “required,” patient screener model 310 will ensure that it selects nodes in the tree such that the node with the “required” is reached in the sequence and selected. In other embodiments of the decision tree, nodes may have zero or more scores. For nodes that have two or more scores, the patient screener model 310 may aggregate the scores using an algorithm such as a weighted average (e.g., one score is more likely to influence a medical diagnosis than another score). Information describing how to the aggregate scores or the algorithm may be manually input by a health expert via the client device 110 and/or received from the provider 150, external source 130, and the databases of the risk assessment service 140.

The risk assessment module 330 assesses a patient's behavioral health risk based on the patient's demographic information and patient's responses to a sequence of screening questions which are customized and adaptive for the patient by the patient screener model 310. In one embodiment, the risk assessment module 330 generates an initial baseline of behavioral health risk of a patient based on the patient's responses to questions regarding the patient's demographic information (e.g., questions shown in FIG. 5A and FIG. 5B). For example, the risk assessment module 330 uses the patient's age along with external source database 160 such as clinical guidelines and research studies identifying risk for depression associated with age groups, to generate an initial baseline of behavioral health risk of the patient in terms of depression. The risk assessment service 140 uses the patient's gender guided by the clinical guidelines and research studies suggesting association of particular gender groups with risk of developing eating disorders, to generate an initial baseline of behavioral health risk of the patient in terms of eating disorder. Further, the risk assessment service 140 may aggregate multiple types of information (e.g., both the patient's age and gender) to generate the initial baseline of behavioral health risk for one or more conditions. The risk assessment module 330 can use other types of demographic data of a patient such as socioeconomic status and medical history, individually or in combination, to generate the initial risk assessment.

The patient may be referred to an appropriate health care provider for further diagnosis or treatment depending on the outcome of the initial risk assessment. Taking the example shown in FIG. 5A, from the patient's provided age, the risk assessment module 330 determines severity of the patient's risk of developing depression. If the user's answer indicates that the patient is in elementary school, (e.g., providing an age of “8”), that means the patient's risk of developing depression is probably not as severe. If the user's answer indicates that the patient is a young adult (e.g., providing an age of “24”), that means the patient's risk of developing depression may be more severe, and more comprehensive diagnosis may be required based on the initial risk assessment. In some embodiments, a report is generated for the patient's primary care physician based on the results of the initial baseline of behavioral health condition risk.

The risk assessment module 330 updates the initial baseline of the patient's behavioral health risk based on the patient's responses to a sequence of personalized and adaptive screening questions presented to the patient (e.g., as shown in FIG. 6A and FIG. 6B). After the patient has responded to each of the screening questions, the risk assessment module 330 compares the patient's responses with one or more clinically derived risk baselines for common behavioral health conditions and determines the behavioral health risk of the patient based on the comparison. For example, based on his/her responses to questions related to depression, if the patient has shown a behavioral health pattern similar to those indicating symptoms of depression supported by the clinically derived data, the risk assessment module 330 determines that the patient is at risk of suffering depression.

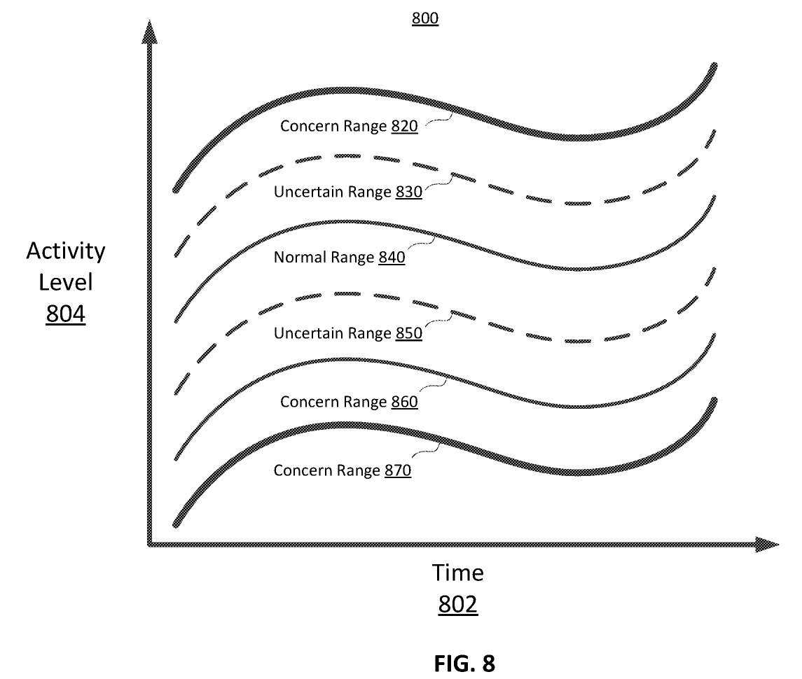

It is noted that a patient's behavioral health conditions are correlated with changes in the patient's activity patterns and/or amount of sleep. In one embodiment, the patient activity model 340 is trained for each patient, e.g., by the machine learning module 320, to establish a normalized baseline of expected behavior of the patient in terms of activity or sleep levels of the patient, which is further described in FIG. 8. The normalized baseline of expected behavior of the patient is controlled by the demographic information of the patient and expected rates of behavioral health diagnoses. The patient activity model 340 is updated continuously using a machine learning scheme (e.g., stochastic gradient descent) and a smooth numerical function (e.g., splines) in response to new activity data about the patient being available. The patient's activity and sleep data can be obtained from the smart devices of the patient (e.g. FITBIT® and APPLE® HEALTHKIT).

### Activity Level Model

Turning now to FIG. 8, FIG. 8 is an example of a chart 800 illustrating normal, uncertain, and concern ranges of a patient's behavioral health risk analyzed by the patient activity model 340 according to one embodiment. In one example, the activity level 804 is the number of hours of sleep that the patient has each day over a time range 802. The normal range 840 represents a boundary of expected behavior of the patient in terms of the activity level 804 over the period of time 802. The boundary of the expected behavior of the patient is established based on the patient's demographic information such as age, gender, ethnicity and medical history, and is continuously updated based on the changes of the patient's activity levels.

The normalized baseline of expected behavior of the patient monitored by the patient activity model 340 is provided to the risk assessment module 330 to augment the behavioral health risk assessment of the patient. In one embodiment, the risk assessment module 330 uses relevant clinical guidelines to determine how the activity and sleep data of the patient contribute to the patient's behavioral health risk assessment. For example, in the case of bipolar risk assessment, a patient's level of activity may indicate the onset of a manic or depressive episode.

Using FIG. 8 in another example, the risk assessment module 330 using relevant clinical guidelines to determine how the activity/sleep data contribute to the patient's behavioral health risk assessment. For example, if the patient shows a behavioral pattern measured in terms of activity level 804 and time 802 falling within the interval defined by the boundary of the normal range 840 and the boundary of the uncertain range 850, the patient's behavioral health risk contributed by the sleep data is determined to be unlikely. On the other hand, if the patient shows a behavioral pattern measured in terms of activity level 804 and time 802 falling within the interval defined by the boundary of the normal range 840 and the boundary of the uncertain range 830, or the interval defined by the boundary of the uncertain range 850 and the boundary of the concern range 860, the patient's behavioral health risk contributed by the sleep data is determined to be uncertain. If the patient shows a behavioral pattern measured in terms of activity level 804 and time 802 falling within the interval defined by the boundary of the uncertain range 830 and the boundary of the concern range 820, or the interval defined by the boundary of the concern range 860 and the boundary of the concern range 870, the patient's behavioral health risk contributed by the sleep data is determined to be likely. If the patient shows a behavioral pattern measured in terms of activity level 804 and time 802 falling within the interval defined above the boundary of the concern range 820, or the interval defined below the boundary of the concern range 870, the patient's behavioral health risk contributed by the sleep data is determined to be the most likely.

In one embodiment, the machine learning module 320 updates the patient activity model 340 over time using training data and/or training sets such as activity data (e.g., food and liquid consumption, exercise, time spent sitting or standing, etc.), sleep data (e.g., duration of deep sleep and light sleep, consistency of wake up times each day) obtained from the smart devices of the patient, and journaling data self-reported by the patient. In one embodiment, monitoring the patient's behavior over time to update the patient activity model 340 (e.g., obtaining data from smart devices) is an opt-in feature of the risk assessment service 140 such that the patient can decide whether or not to opt in to allowing the monitoring to occur. The machine learning module 320 may aggregate activity and sleep data from a group of two or more patients that have similar profiles, and use the aggregated data to train the patient activity models 340 of each patient in the group. For instance, the machine learning module 320 may aggregate the average and standard deviation of the number of hours that patients between the ages of 13 and 18 sleep each day because adolescents in this age range are expected to typically sleep about the same number of hours each day.

Patient activity data used by the machine learning module 320 to train the patient activity models 340 can also be used by the patient screener model 310 to intelligently select screening questions for patients. Following in the same example, the machine learning module 320 may also use this aggregated sleep data to select future screening questions for a patient. In particular, if the patient is a 15 year old (i.e., in the 13 to 18 year old age range) who indicates in a response to a screening question that she sleeps less than the average number of hours by a standard deviation for the 13 to 18 year old age range, then the machine learning module 320 may update the decision tree (e.g., in the patient's patient screener model 310) to select future screening questions related to sleep habits. For instance, the scores corresponding to nodes of sleep related questions may be increased in score value, i.e., the information gain from sleep related questions will be increased because the patient screener model 310 will select more questions of this type.

### Personalized Risk Assessment Service

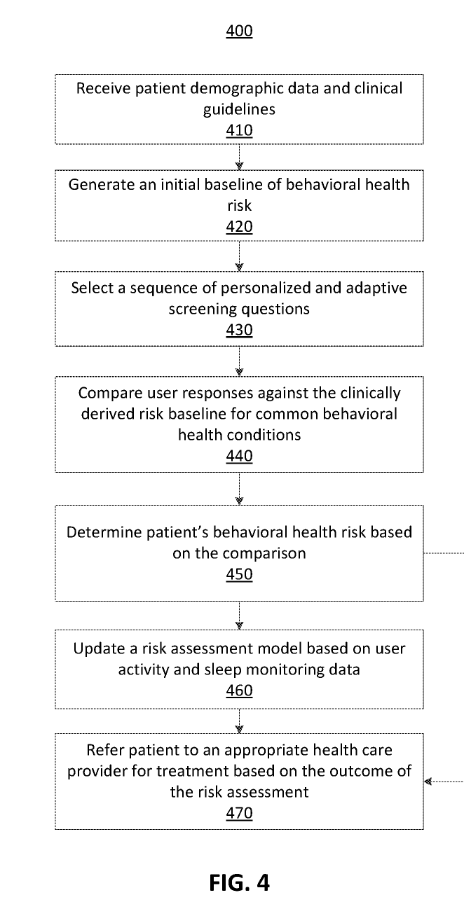

FIG. 4 is an exemplary flowchart illustrating a process 400 of determining behavioral health risk of a patient performed by the risk assessment service 140 according to one embodiment. The process 400 may include different or additional steps than those described in conjunction with FIG. 4 in some embodiments or perform steps in different orders than the order described in conjunction with FIG. 4.

The risk assessment service 140 initially receives 410 a patient's demographic information (e.g., age and gender) from user input data and clinical guidelines from the external source 130 and/or external source database 160. The risk assessment service 140 generates 420 an initial baseline of behavioral health risk based on the received data. To accurately determine the patient's behavioral health risk, the risk assessment service 140 selects 430 a sequence of personalized and adaptive screening questions for the patient. For example, the machine learning module 320 of the risk assessment service 140 trains the patient screener model 310 to select the sequence of customized questions from multiple candidate questions; a subsequent question in the sequence is selected based on the patient's answer to the previously presented screening question.

Upon receiving the patient's answers to the sequence of screening questions, the risk assessment service 140 compares 440 the user responses with one or more clinically derived risk baselines for common behavioral health conditions and determines 450 the patient's behavioral health risk. Depending on the determined risk, the risk assessment service 140 refers 470 the patient to an appropriate health care provider for treatment. For example, if the patient was an elderly person determined to have a severe risk of developing depression, then the risk assessment service 140 may refer the patient to a psychiatrist who specializes in treating depression for the elderly. Responsive to receiving activity and sleep monitoring data of the patient, the risk assessment service 140 updates 460 machine learning models in the patient's personalized risk assessment module 300 by analyzing the contribution to the behavioral health risk from the received activity and sleep monitoring data.

In one embodiment, the risk assessment service 140 uses a patient's answers to the sequence of screening questions and/or the determined behavioral health risk for the patient to categorize the patient as a high (or low) cost individual. In particular, a patient with a high risk for a behavioral health condition is likely to incur high health care costs due to their behavioral health condition, e.g., emergency room or intensive outpatient partial hospitalization programs. Further, the risk assessment service 140 can also categorize the patient's risk for low productivity and/or low functionality due to behavioral health. For example, a patient who has a high risk for alcoholism is more likely to have lower productivity on a job due to absenteeism (i.e., productivity lost by not showing up to work) and/or presenteeism (i.e., productivity lost by showing up to work, but not being fully functional).

### Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a nontransitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving demographic information describing a patient;
generating an initial baseline of behavioral health risk associated with the patient based on the received demographic information;
selecting a sequence of questions that are personalized to evaluate behavioral health risk of the patient, each subsequent question in the sequence presented to the patient being selected based the patient's response to at least one previous question in the sequence;
comparing responses to the sequence of questions from the patient with at least one clinical guideline related to behavioral health assessment; and
determining the patient's behavioral health risk based on the comparison.

2. The method of claim 1, wherein the behavioral health conditions comprise at least one of the following:
depression;
anxiety;
alcohol or substance abuse;
attention deficit hyperactivity disorder (ADHD);
post-traumatic stress disorder (PTSD);
specific phobia;
social anxiety;
bipolar disorder; and
schizophrenia or psychosis.

3. The method of claim 1, further comprising:
training a model using a plurality of training data for selecting; and
selecting the sequence of questions that are personalized to evaluate behavioral health risk of the patient using the trained model.

4. The method of claim 3, wherein training the model comprises:
training the model using a decision tree, wherein each node of the tree represents a value of a candidate question selected from the plurality of training data, and the candidate questions are distributed to sets of two or more nodes of the decision tree according to a structure of the decision tree.

5. The method of claim 4, wherein selecting the sequence of questions comprises:
selecting a question from a set of one or more nodes of the decision tree based on a comparison of information gain provided by each of the candidate questions corresponding to the two or more nodes in the set, wherein the selected question provides more information about the patient's behavioral health risk than at least one other candidate question in the set.

6. The method of claim 1, further comprising:
identifying a health care provider for the patient based on the patient's determined behavioral health risk; and
providing information regarding the identified provider to the patient.

7. The method of claim 1, further comprising:
receiving information describing activity levels over a period of time of the patient;
analyzing contribution from the activity levels of the patient to the behavioral health risk of the patient; and
updating the determined behavioral health risk of the patient based on the analysis of contribution from the activity levels of the patient.

8. The method of claim 7, wherein analyzing the contribution from the activity levels of the patient to the behavioral health risk of the patient comprises:
training an activity model for the patient, the trained activity model describing correlation between behavioral health conditions of the patient and changes in activity levels of the patient; and
establishing a normalized baseline of expected behavior of the patient based on the received demographic information describing the patient.

9. The method of claim 7, wherein analyzing the contribution from the activity levels of the patient to the behavioral health risk of the patient further comprises:
updating the activity model in response to changes of the activity levels of the patient.

10. The method of claim 1, further comprising:
presenting the selected a sequence of questions in a graphical user interface, the questions being presented according to an order such that the patient response to each subsequent question represents increased information for assessing the patient's behavioral health risk; and
receiving the patient's responses to the sequence of questions through the graphical user interface.

11. A non-transitory computer-readable storage medium storing executable computer program instructions, the computer program instructions comprising code for:
receiving demographic information describing a patient;
generating an initial baseline of behavioral health risk associated with the patient based on the received demographic information;
selecting a sequence of questions that are personalized to evaluate behavioral health risk of the patient, each subsequent question in the sequence presented to the patient being selected based the patient's response to at least one previous question in the sequence;
comparing responses to the sequence of questions from the patient with at least one clinical guideline related to behavioral health assessment; and
determining the patient's behavioral health risk based on the comparison.

12. The computer-readable storage medium of claim 11, wherein the behavioral health conditions comprise at least one of the following:
depression;
anxiety;
alcohol or substance abuse;
attention deficit hyperactivity disorder (ADHD);
post-traumatic stress disorder (PTSD);
specific phobia;
social anxiety;
bipolar disorder; and
schizophrenia or psychosis.

13. The computer-readable storage medium of claim 11, wherein the computer program instructions further comprises code for:
training a model using a plurality of training data for selecting; and
selecting the sequence of questions that are personalized to evaluate behavioral health risk of the patient using the trained model.

14. The computer-readable storage medium of claim 13, wherein training the model comprises:
training the model using a decision tree, wherein each node of the tree represents a value of a candidate question selected from the plurality of training data, and the candidate questions are distributed to sets of two or more nodes of the decision tree according to a structure of the decision tree.

15. The computer-readable storage medium of claim 14, wherein selecting the sequence of questions comprises:
selecting a question from a set of one or more nodes of the decision tree based on a comparison of information gain provided by each of the candidate questions corresponding to the two or more nodes in the set, wherein the selected question provides more information about the patient's behavioral health risk than at least one other candidate question in the set.

16. The computer-readable storage medium of claim 11, wherein the computer program instructions further comprises code for:
identifying a health care provider for the patient based on the patient's determined behavioral health risk; and
providing information regarding the identified provider to the patient.

17. The computer-readable storage medium of claim 11, wherein the computer program instructions further comprises code for:
receiving information describing activity levels over a period of time of the patient;
analyzing contribution from the activity levels of the patient to the behavioral health risk of the patient; and
updating the determined behavioral health risk of the patient based on the analysis of contribution from the activity levels of the patient.

18. The computer-readable storage medium of claim 17, wherein analyzing the contribution from the activity levels of the patient to the behavioral health risk of the patient comprises:
training an activity model for the patient, the trained activity model describing correlation between behavioral health conditions of the patient and changes in activity levels of the patient; and
establishing a normalized baseline of expected behavior of the patient based on the received demographic information describing the patient.

19. The computer-readable storage medium of claim 17, wherein analyzing the contribution from the activity levels of the patient to the behavioral health risk of the patient further comprises:
updating the activity model in response to changes of the activity levels of the patient.

20. The computer-readable storage medium of claim 11, wherein the computer program instructions further comprises code for:
presenting the selected a sequence of questions in a graphical user interface, the questions being presented according to an order such that the patient response to each subsequent question represents increased information for assessing the patient's behavioral health risk; and
receiving the patient's responses to the sequence of questions through the graphical user interface.

21. A computer-implemented method comprising:
selecting a sequence of questions related to behavioral health assessment that are personalized for a patient, each subsequent question in the sequence presented to the patient being selected based the patient's response to at least one previous question in the sequence;
comparing responses to the sequence of questions from the patient with at least one clinical guideline related to the behavioral health assessment; and
determining the patient's behavioral health risk based on the comparison.
